(19) United States
(12) Patent Application Publication
(10) Pub. No.: US 2013/0180495 A1
(43) Pub. Date: Jul. 18, 2013

(54) Detachable Power Head

(71) Applicants: Jay S. Veerathappa, Los Angeles, CA (US); Sharu Rajgiri, Suwanee, GA (US)

(72) Inventors: Jay S. Veerathappa, Los Angeles, CA (US); Sharu Rajgiri, Suwanee, GA (US)

(21) Appl. No.: 13/350,739

(22) Filed: Jan. 14, 2012

(51) Int. Cl. F02B 67/04; F16B 7/22

(52) U.S. Cl. 123/195 A; 403/315; 403/33

(57) ABSTRACT

A detachable power head (200) and a detachable equipment (500, 900) provided for hand held applications; such as a trimmer, blower, etc. The power head includes an internal combustion engine and a ring on the housing and a matching ring on the power equipment for easy attachment of the power head to the equipment.

### BACKGROUND

The present invention relates to hand held equipments in general and lawn and garden equipment in particular. The current equipments, for example, trimmer, blowers, generators, cultivators, water pumps, etc, including go-peds all each have internal combustion engines or electric motors, which are either battery powered or electrical motors. Each equipment powered, particularly by the internal combustion engines more or less are all about the same power ratings and even operate within the same RPM ranges. The disadvantage to the customer is that not all the equipments are used year long and in most cases they are used seasonally. Sometimes, they are rarely used, such as the emergency power generators. As such, the disadvantages are that the consumer has to pay for each engine and have to maintain them regularly, whether the equipment is used or not. Secondly, the equipment typically carry about one to two years warranty, which means the warranty simply expires even if the engine is not used for the reasonable number of hours a year. Thirdly, each of the equipments mostly likely requires carburetor or fuel treatment for long term storage and annual maintenance. Also, in most cases, the lubricating oil in each of the engines, has a limited shelf life and need to be periodically changed. Changing the oil means expense and polluting the environment. As such, the real life cycle cost of each equipment is unnecessarily higher and wasteful. In most cases, the useful life of the engine is about 5 to 8 years and during the life of the engine, the emission standard typically become stringent. This means the older engines keep polluting even though cleaner engines are available in the market.

The present invention resolves many of the disadvantages described above. The present invention relates to detachable power head system where an engine or an electric motor could be attached and detached easily by the consumer to power any of the equipments, including but not limited to trimmer, blower, generator, back pack blower, water pump, sprayer, electric generator, chainsaw, etc, including go-peds. The embodiment consists of a mechanism where power heads are aligned with the locating groves on the equipment and fastened easily either by simple twist and lock or clamps or even bolt and nut type of fastening devices. The advantages are that the consumers need to purchase and maintain only one engine or a motor. There are, however, different attachments for a trimmer engine are available, such as a blower, tiller, edger etc that are attached to the upper boom. However, the attachments are not designed for optimum performance and become heavy, particularly when a blower or a cultivator attachment is attached to a trimmer engine having an upper boom. Whereas with the current invention, the blower, for example can be large and designed for best air flow and as good as dedicated blower. The engine or the motor in the case of the current invention can be attached to a cultivator or an edger on wheels, while getting the best performance out of the complete system. The power head can also contain fuel tank, lubricating tank, if separate, and starter assembly. An external electric start can be used to make the entire unit light weight and compact. When internal combustion engine is used to drive the equipment, it can be a four-stroke, two-stroke, or a rotary engine using either liquid or gaseous fuels. The engine can be either wet or dry lubricated or oil injected engine as in a two-stroke engine. The four-stroke engine may also be a mist lubricated as in Honda's trimmer or Stihl's pre-mix 4 stroke engine trimmer. The oil tank could be attached to the power head or to the equipment. The electric motor can be a corded or cordless battery operated motor or for that matter even an air powered motor. The secondary advantage with an universal type attachment mechanism is that any size engine or engine from different manufacturers can be used on a single equipment. Thus provides the consumer a variety of freedom to choose equipment and engines from different manufacturers. Also, with the advancement of the engine technologies, same equipment can be retained while upgrading only the engine. When an engine has to be thrown away in case the engine cannot be repaired, then the consumer can buy only the engine for lower cost and yet keep his or her old equipment. Thus the current invention is more earth friendly and sustainable.

### BRIEF SUMMARY

The power head described here pertains to an internal combustion engine of two or four-stroke type and it may use any type of fuel, liquid or gaseous. Fuel delivery system can be carbureted or fuel injected type or a combination of fuel injection and carburetor (mixer) type. The power head shown in Figures in this invention is an internal combustion engine, but an electric or a compressed air powered motor can be used. In the present invention, a trimmer and a blower are shown, only as examples. It must be understood that many different types of equipments can used. The accompanying drawings show a power head 200, which is an internal combustion engine attached to an equipment, a trimmer 500 in this case is shown in FIG. 1 and the same power head 200 is shown attached to a different equipment, a hand held blower 900 in FIG. 5. One of the different methods of attaching the power head to the equipment is shown in FIGS. 3 and 4, which consist of a ring 800 an integral part of the equipment (500 and 900) and a matching ring 880, which is an integral part of the power head 200. The rings consist of radial groves 812 on ring 800 and the radial hooks 830 on the ring 880. The hooks 830—slide into the radial cut out 812 and the radial hooks are twisted to locking position so that the equipment and the power head are rigidly engaged power transmission from the power head to the equipment. To secure the power head and the equipment, additional fastener, clamps, or grooved ring can be used. Each of the rings, 800 and 880 have a matching parts for the kill switch and the throttle operation. Thus any equipment having a matching ring 800 can be hooked to the power head 200. Thus, multiple equipment can be used having just one power head. Detailed description of the current invention will be discussed in the section detailed description.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

The features and advantages of the present invention may be better understood by reference to the accompanying drawings in which like reference numerals refer to like elements.

FIG. 1 is a side sectional view of the trimmer having the detachable power head 200 attached to the trimmer boom 500 per present invention.

FIG. 2 is the view of the trimmer shown in FIG. 1 with the power head 200 and trimmer boom 500 detached from each other.

FIG. 3 (a) is a view of the ring 800 showing only the ring and the associated features.

FIG. 3 (b) is a view of the ring 880 showing only the ring and the associated features.

FIG. 4 is a view of both the rings 800 and 880 aligned and in final position.

FIG. 5 is a side sectional view of the hand held blower having the detachable power head 200 attached to the blower 900 per present invention.

FIG. 6 is the view of the blower shown in FIG. 5 with the power head 200 and the blower 900 detached from each other.

FIG. 7 Shows section view of a V band assembly.

FIG. 8 Shows section view of threaded assembly.

FIG. 8 Shows clamp type assembly.

While this invention is susceptible of several different embodiments, this specification and the accompanying drawings disclose only some specific forms as examples of the invention. The invention is not intended to be limited by the descriptions in this specification or the drawings. Instead, the scope of the invention is provided in the claims.

### DETAILED DESCRIPTION

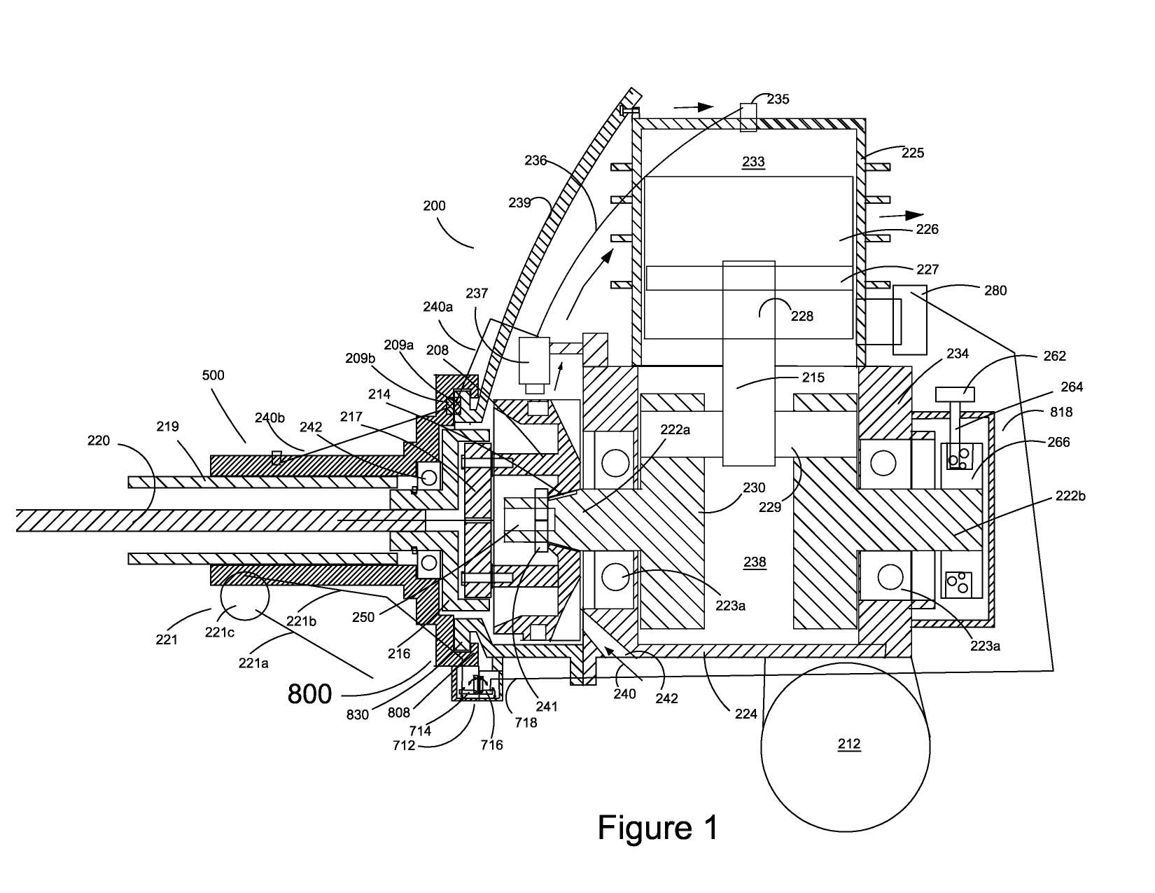

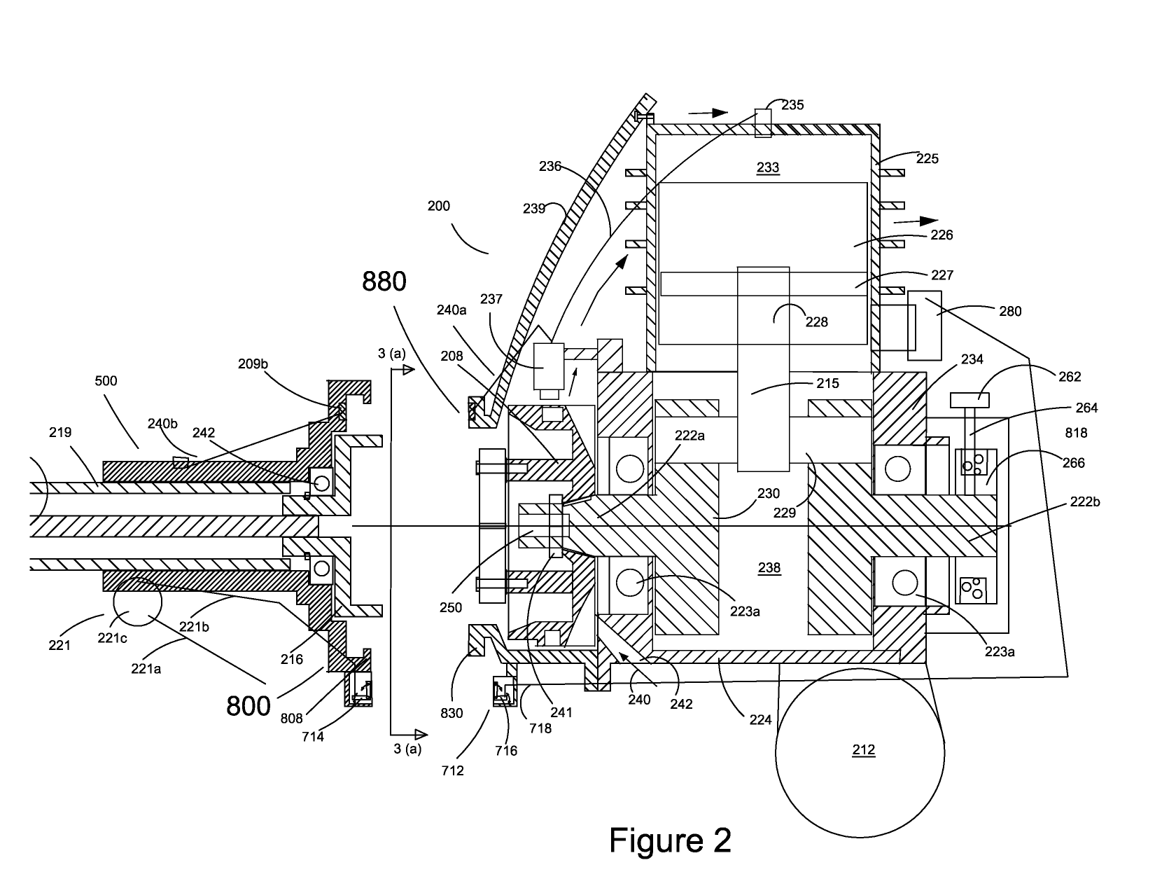

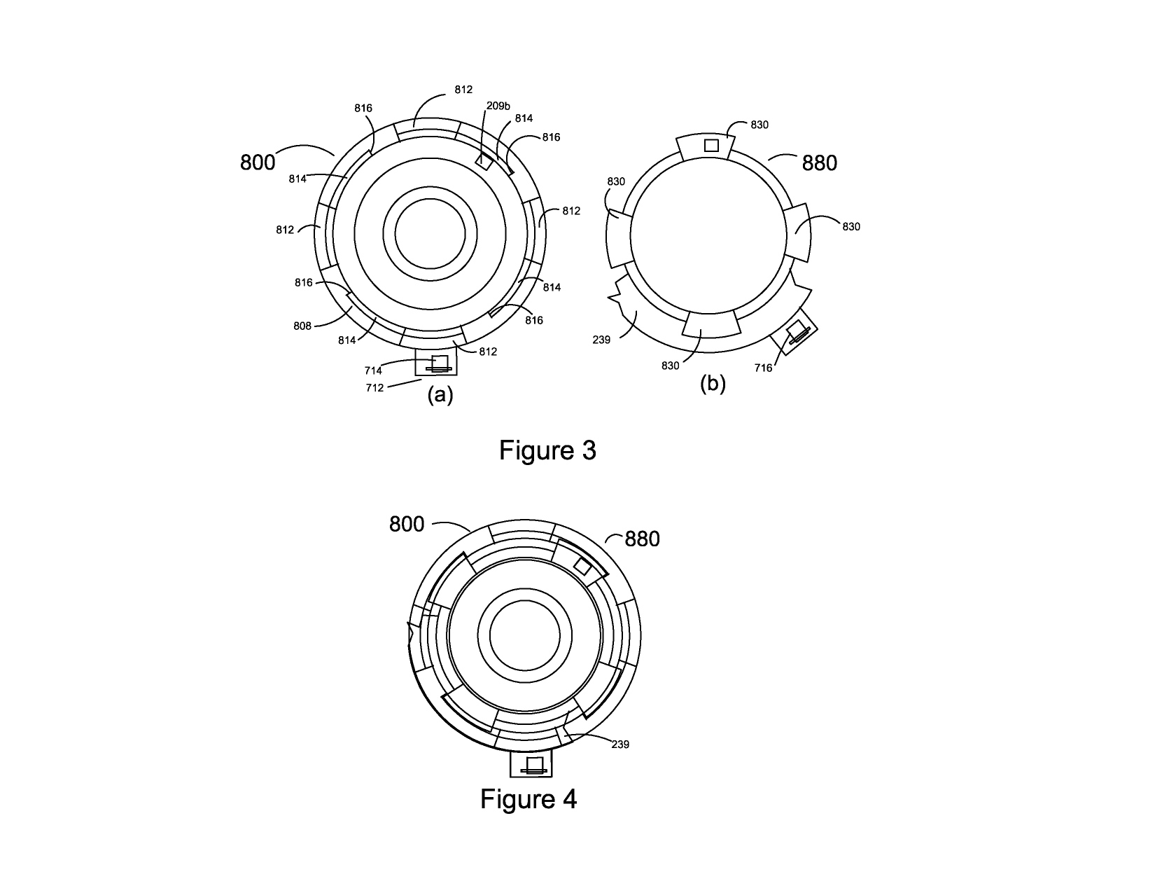

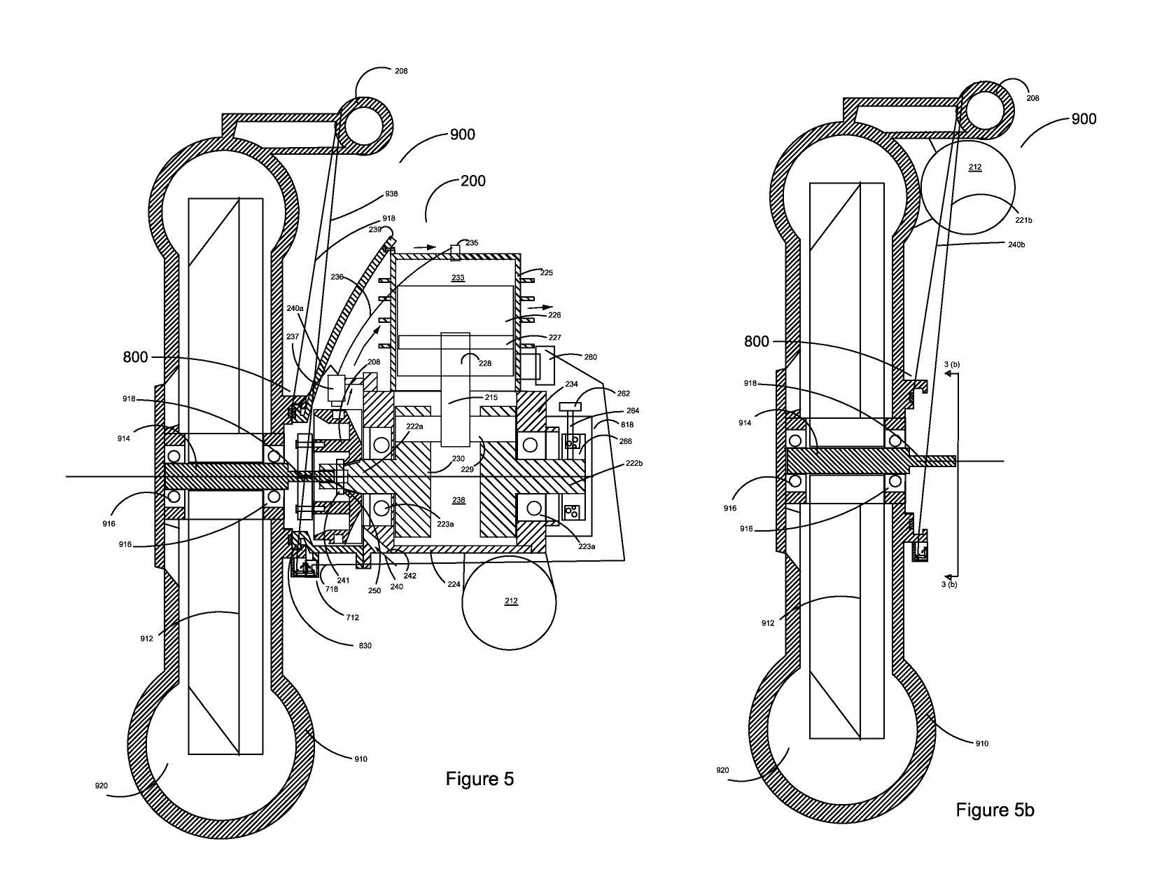

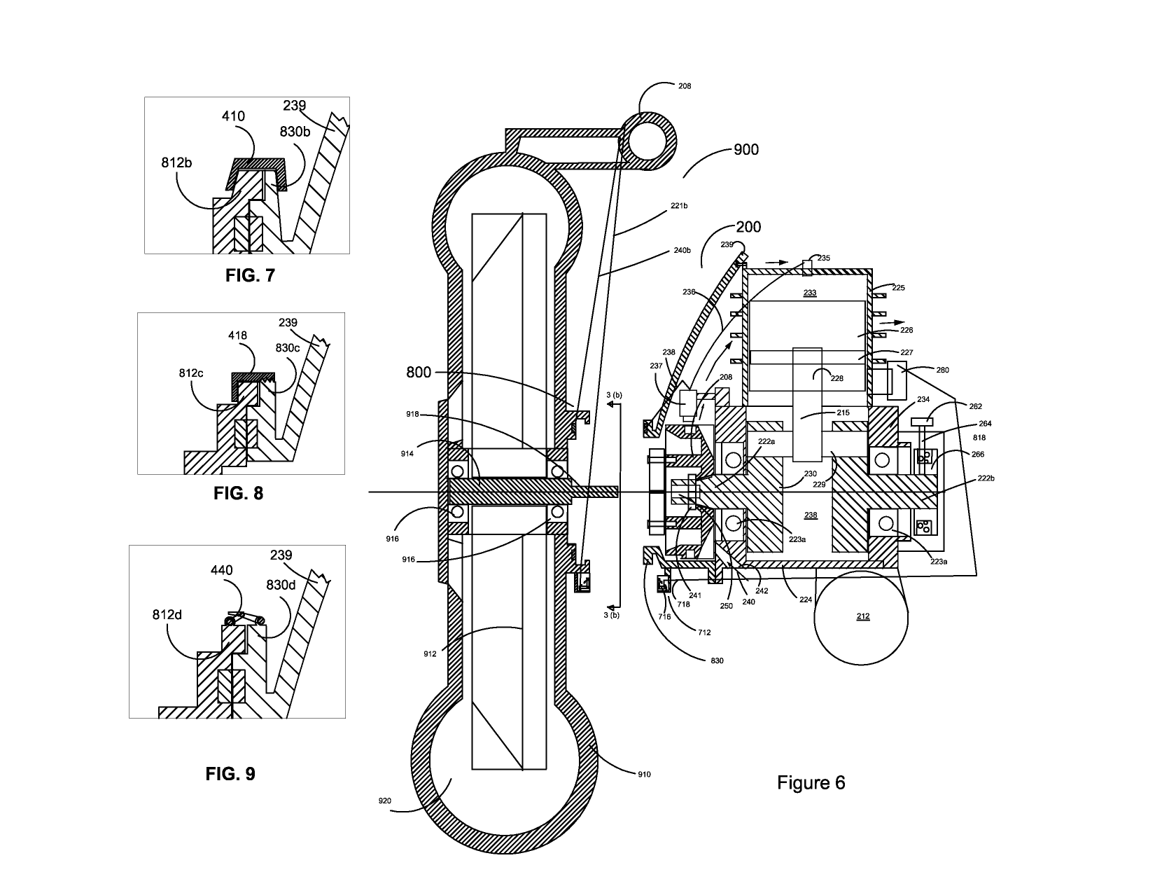

Embodiments in accordance with the present invention will be described below with references to FIGS. 1 to 7. FIG. 1 is a side sectional view of trimmer equipment 500 showing only partial section of the upper boom 219 and the shaft 220. The power head 200 shown as an example here is an internal combustion engine having a reciprocating piston 226 in a cylinder 225. The construction and functionalities of the engine is well known to anyone skilled in the art. Any type of power head can be used. For example the power head can be a two-stroke engine or a four-stroke engine having intake and exhaust valves. The internal combustion engine can be fueled by any type of liquid fuel, such as gasoline, diesel, kerosene, ethanol, etc. The internal combustion engine can be fueled by any type of gaseous fuel, such as LPG, methane, natural gas, hydrogen, etc. The power head can also be driven by compressed gas, such as air or CO2, for example. Alternatively, the power head can be an electrical motor operated AC current or a battery operated electric motor. Alternatively, it could be a rotary engine or a turbine or a water pressure operated turbine. It is not limited to the type of power head described here. The key feature of the invention is a detachable power head using a coupling mechanism to attach and detach any equipment easily to the power head with no tool or minimum tool. Where any unskilled person can attach and detach a power head to the equipment. The equipment can be any useful product that requires a power head, preferably a portable equipment, in particular a hand held equipment or a small engine operated equipment. As example, the present invention shows a trimmer equipment and a blower equipment in the accompanying drawings. However, it must be understood that any type of hand held or portable equipment may be used, including wheeled equipment and go-peds, mini-scooters, remote controlled air planes. Example of equipment include, but not limited to back pack blower, cultivator, edger, generator, water pump, compressor, powered tool (such as drills), augors, vacuum, go-peds, etc. The present invention is probably akin to power outlets at home, where the many appliances, including lights are plugged into the wall outlet to power the appliances. Similarly a single power head can power many different equipment, one at a time, however.

The key feature, as an example consists of rings one each ne the power head and the equipment. The ring 880 is an integral part of the housing 239 on the power head 200. The ring 239 can be fastened to the power head housing or can be an integral part of the housing. Similarly the ring 800 can be an integral part of the equipment or can be fastened to the housing of the equipment.

The ring 800 consists radial groves 812, which are multiple in number and are the radially cut outs of circumferential lip 808. The radial grove has vertical grove to guide the radial hook 830 on the ring 880 of the power head. The circumferential lip 808 has circumferential grove 814 into which the radial hook fits into when the ring 880 is twisted to lock position. Appropriate stop 816 is provided in the ring 800 to bring the two rings to proper final position where the kill switch contacts 209a and 209b are in position and in contact with each other. Similarly the throttle connector assembly 712 is aligned and in proper final position for actuation of the throttle in the fuel mixer when the throttle lever 221a is operated. The two rings 800 and 880 can be locked in position tool-lessly as better described in U.S. Pat. No. 5,918,574 for example. In the U.S. Pat. No. 5,918,574 is, however, used to lock the fuel container in position and not for the attachment and detachment of power head. Any similar connector devices can be used. Alternatively a simple V-band can be used to lock the two rings. For example V-band are used to lock the turbine and a compressor in an automobile turbo-charger. Alternatively clamps as used in suit cases or air filter covers can also be used. Nuts with wing nut where the bolt can swing open, while being hinged on the ring can also be used.

Typically, some equipment may need clutched operation so that the equipment is not operational when the power head is idling or running at very low RPM. For such applications, the equipment may have a clutch drum 216 such that the clutch 217 on the power head drives the equipment only above certain power RPM. However, in certain other types of equipment, blower for example may not need clutch. In that case the drive shaft 918 may engage the crankshaft 22a directly through the external and internal splines, 250 and 918 respectively. The clutch 217 may have a hub at the center having an internal spline. Alternatively the crankshaft 22a may have internal spline cut at the outer end.

The accompanying drawings for the power head have an outboard starter assembly 818, which consists of a pulley 816 and a rope 814 with the handle 812. However, the starter assembly can also be on the inboard side (near the flywheel 208). Alternatively, the power head may be completely devoid of any built in starter assembly, but may have an external starter (external to the power head, which is also a detachable type, as in the case of an MTD's trimmer, where an electric starter is employed to start the engine.

The following are embodiments, not claims:
A. A detachable power head (200) comprising:
(a) a housing (239);
(b) a ring (880) integrally mounted to the housing (239);
(c) at least one locating hook (830) on the ring (880);
   B. A detachable equipment comprising:
(a) a housing of an equipment (900);
(b) a ring (800) integrally mounted to the housing (910) of an equipment (900);
(c) at least one locating grove (812) on the ring (800);
   C. A detachable power head (200) comprising:
(a) a housing (239);
(b) a V-ring (608) integrally mounted to the housing (239);
(c) at least one locating projection (612) on the ring (608);
   D. A detachable equipment comprising:
(a) a housing of an equipment (900);
(b) a V-ring (610) integrally mounted to the housing (910) of an equipment (900);
(c) at least one locating grove (614) on the ring (610);
   E. An equipment of embodiment B being a trimmer;
   F. An equipment of embodiment B being a blower;
   G. An equipment of embodiment B being a generator;
   H. An equipment of embodiment B being a backpack blower;
   I. An equipment of embodiment B being a water pump;
   J. An equipment of embodiment B being a compressor;
   K. An equipment of embodiment B being a edger;
   L. An equipment of embodiment B being a cultivator;
   M. An equipment of embodiment B being a go-ped;
   N. An equipment of embodiment B being a chainsaw;
   O. An equipment of embodiment B being a hedge cutter;
   P. An equipment of embodiment B being a auger;
   Q. A power head (200) of embodiment A being an internal combustion engine;
   R. A power head (200) of embodiment A being an electrical motor;
   S. A power head (200) of embodiment A being rotary engine;
   T. A power head (200) of embodiment A being a turbine;
   U. A power head (200) of embodiment A being self contained power head;
   V. A power head (200) of embodiment A having an integral handle;
   W. A power head (200) of embodiment A having a starter assembly;
   X. A power head (200) of embodiment A having fuel tank (212) attached to the power head (200);
   Y. A power head (200) of embodiment A being an internal combustion engine and having an external starter;
   Z. A power head (200) of embodiment A being an half crank internal combustion engine;
   AA. A power head (200) of embodiment A being an full crank internal combustion engine;
   BB. A power head (200) of embodiment A being an internal combustion engine is fueled by liquid fuel;
   CC. A power head (200) of embodiment A being an internal combustion engine is fueled by gaseous fuel;
   DD. A power head (200) of embodiment A being an internal combustion engine is fueled injected engine;
   EE. A power head (200) of embodiment A being an internal combustion engine is oil injected for lubrication;
   FF. A power head (200) of embodiment A being an internal combustion engine has fuel and oil tanks attached to the engine (200);
   GG. An equipment (500/900) of embodiment B has fuel tank attached to the frame;
   HH. An equipment (500/900) of embodiment B has oil tank attached to the frame;

### LIST OF ELEMENTS

200 power head
208 flywheel
209a contact 1—kill switch
209b contact 2—kill switch
212 fuel container
214 key way
216 clutch drum
217 clutch
219 trimmer boom
220 Drive shaft
221 throttle assembly
221a throttle lever
221b throttle link (cable)
221c throttle lever hinge
222a inboard crankshaft
222b outboard crankshaft
223 a main bearing
224—crankcase
225 engine block—cylinder
226 piston
228 connecting rod
229 crank pin
233 combustion chamber
234 outboard crankcase cover and bearing housing
235 spark plug
236 spark plug wire
237 ignition module
238 crankcase chamber
239 housing—power head
240a kill switch wire—power head
240b kill switch wire—equipment
241 flywheel nut
242 clutch drum bearing
250 internal spline
262 starter handle
264 starter rope
266 starter pulley assembly
280 fuel mixer (carburetor, injection throttle body)
500 equipment—trimmer
600 V-band assembly
608 V ring—power head
610 V ring equipment
612 locating projection
614 locating grove
618 V band
622 V band fastener
716 bell crank power head
718 throttle cable
800 equipment ring
808 circumferential lip
812 radial grove
814 circumferential grove
830 radial hook
880 power head ring
900 equipment—blower
908 handle—blower
912 blower fan
914 blower shaft
916 blower bearing
918 splined shaft

The foregoing disclosure is the best mode devised by the inventors for practicing this invention. It is apparent, however, that apparatus incorporating modifications and variations will be obvious to one skilled in the art. Inasmuch as the foregoing disclosure is intended to enable one skilled in the pertinent art to practice the instant invention, it should not be construed to be limited thereby but should be construed to include aforementioned obvious variations and be limited only by the spirit and scope of the following claims.

It is therefore intended that the foregoing detailed description be regarded as illustrative rather than limiting, and that it be understood that it is the following claims, including all equivalents, that are intended to define the spirit and scope of this invention.

1. A detachable power head (200) comprising:
(a) a housing (239);
(b) a ring (880) integrally mounted to the housing (239); and
(c) at least one locating hook (830) on the ring (880).

2. The power head (200) of claim 1, in which the power head is one of: (a) an internal combustion engine; (b) an electrical motor; (c) a rotary engine; (d) a turbine; and (e) a self contained power head.

3. The power head (200) of claim 1 further comprising an integral handle.

4. The power head (200) of claim 1 further comprising a starter assembly.

5. The power head (200) of claim 1 further comprising a fuel tank (212) attached to the power head (200).

6. The power head (200) of claim 1, in which the power head is an internal combustion engine and further comprises an external starter.

7. The power head (200) of claim 1, in which the power head is a half crank internal combustion engine.

8. The power head (200) of claim 1, in which the power head is a full crank internal combustion engine.

9. The power head (200) of claim 1, in which the power head is an internal combustion engine fueled by liquid fuel.

10. The power head (200) of claim 1, in which the power head is an internal combustion engine fueled by gaseous fuel.

11. The power head (200) of claim 1, in which the power head is an internal combustion engine that is a fuel injected engine.

12. The power head (200) of claim 1, in which the power head is an internal combustion engine and has oil injected for lubrication.

13. The power head (200) of claim 1, in which the power head is an internal combustion engine with fuel and oil tanks attached to the engine (200).

14. A detachable power head (200) comprising:
(a) a housing (239);
(b) a V-ring (608) integrally mounted to the housing (239); and
(c) at least one locating projection (612) on the ring (608).

15. A detachable equipment comprising:
(a) a housing of an equipment (900);
(b) a ring (800) integrally mounted to the housing (910) of an equipment (900); and
(c) at least one locating grove (812) on the ring (800).

16. The equipment of claim 15 in which the ring is a V-ring (610).

17. The equipment of claim 16, in which the equipment is one of: (a) a trimmer; (b) a blower; (c) a generator; (d) a backpack blower; (e) a water pump; (f) a compressor; (g) an edger; (h) a cultivator; (i) a go-ped; (j) a chainsaw; (k) a hedge cutter; and (l) an auger.

18. The equipment of claim 16 further including a fuel tank attached to the frame.

19. The equipment of claim 16 further including an oil tank attached to the frame.
